(19) United States
(12) Patent Application Publication
(10) Pub. No.: US 2015/0219589 A1
(43) Pub. Date: Aug. 6, 2015

(54) MICRO-FLUIDIC ION-SELECTIVE SENSOR AND MEASUREMENT OF AN ANALYTE USING THE SAME

(71) Applicant: CSEM Centre Suisse d'Electronique et de Microtechnique SA-Recherche et Dévelopment, Neuchâtel (CH)

(72) Inventors: Silvia Generelli, Locarno (CH); Laurent Barbe, Zizers (CH)

(73) Assignee: CSEM Centre Suisse d'Electronique et de Microtechnique SA-Recherche et Dévelopment, Neuchâtel (CH)

(21) Appl. No.: 14/421,399

(22) PCT Filed: Aug. 14, 2013
(86) PCT No.: PCT/EP2013/067045

§ 371 Date: Feb. 12, 2015

Related U.S. Application Data
(60) Provisional application No. 61/683,852, filed on Aug. 16, 2012.

(51) Int. Cl. G01N 27/333

(52) U.S. Cl. CPC G01N 27/333

(57) ABSTRACT

Ion-selective sensor (6) comprising a micro-machined chip with an analyte micro-channel (2), adapted to draw an analyte solution and a first liquid membrane micro channel (3) adapted to draw a liquid membrane solution, and an first electrolyte micro channel (1), adapted to draw an analyte solution. The ion-selective sensor (6) comprises a first substrate (100) and a second substrate (200) comprising each a structured surface to form, after assembly of said substrates the analyte micro-channel (2), the first electrolyte micro channel (1) and the first liquid membrane micro channel (3), each provided with their respective inlet and outlet.

### TECHNICAL FIELD

The present invention relates to a low-cost disposable ion-selective sensor and concerns more particularly an ion-selective sensor comprising ion-selective electrodes comprising fluidic micro channels, aimed for long-term monitoring applications.

### BACKGROUND OF THE INVENTION

Potentiometric ion-selective sensors are extremely easy, label-free methods of measurement. The measurement of a potentiometric ion-selective sensor is based on the equilibrium of ions between the different phases of the sensor and at the sensor/analyte interface. This means that the different phases are potentially affected by the measurement, due to exchange of chemical species. These changes lead to a drift in the signal, and eventually to a degradation of the signal. This causes the need for frequent recalibration as well as a degradation of the sensor. Ion sensing is a routine technology in many analytical laboratories, which is used for timepoint measurements. In the past, measurements of ionic concentration were often made by ion-selective microsensors based on a glass micropipette, requiring special pipet fabrication equipments. These types of electrodes are thin and fragile and cannot withstand harsh environments. Also, most of the current miniaturized ion-selective devices on the market are not suited for long-term monitoring. In fact, miniaturized ion-selective electrodes have a limited lifetime, due to the degradation of the materials and/or of the interfaces geometry, which can partly be due to stagnating liquids at the level of the ion sensing membrane. This can lead to changes in the interfacial equilibrium of the ions.

Although, miniaturized ion-selective sensors are at this day available on the market, their use is mainly still limited to single-use sensors.

The ideal miniaturized sensor is an all-solid-state sensor. This means that the sensor is completely solid. The conventional ion-selective electrodes however have a liquid aqueous internal electrolyte. Although more rigid than conventional electrodes, coated wire electrodes and CHEMFETS have the membrane directly coated respectively onto a metal wire and the gate region of a solid-state field effect transistor.

The miniaturization has been performed by exchanging of the conventional aqueous phase with for example hydrogels, conductive polymers (Bobacka, Electroanalysis 18, 2006, No. 1, pp. 7-18), carbon nanotubes (G. Crespo, Anal. Chem., 2008, 80(4), pp. 1316-1322), but without reaching the stability of a conventional electrode.

In their article “integrated potentiometric detector for use in chip-based flow cells”, Anal. Chem, 2000, 72, pp. 2875-2878, R. Tantra and A. Manz disclose a new kind of potentiometric chip sensor for ion-selective sensors based on a solvent polymeric membrane. They propose a method based on a micro machined ion-selective sensor chip to overcome problems presented by surface effects occurring in coated wire electrodes and also by CHEMFETS. The proposed micro machined ion-selective sensor chip by R. Tantra and A. Manz comprises a micro channel for the analyte solution and a micro channel junction structure containing a liquid membrane that separates the analyte from the electrolyte solution. The solution proposed by R. Tantra and A. Manz still requires an electrode reservoir and a conventional Ag/AgCl electrode, which may lead to long-term drift problems due to the stagnating electrode volume. The proposed solution is not fully integrated in a microchip, so that the proposed method is still semi-standard and this difficult to industrialize. The fact that the solution proposed in A. Manz is not fully integrated in a microchip limits as well the possibility of integration of multiple sensors on a single device.

### SUMMARY OF THE INVENTION

The invention intends to solve the limitations of ion-selective sensors of prior art and relates more precisely to an ion-selective sensor which comprises a micro machined chip in which three micro channels are micro machined:
an analyte micro channel, adapted to draw an analyte solution;
an electrolyte micro channel, adapted to draw an electrolyte solution; and
a liquid membrane micro channel adapted to draw an ion-selective liquid membrane solution.

The ion-selective sensor comprises further at least two substrates:
a first substrate that comprises a first electrolyte micro channel integrated on one of its surfaces, this first surface also comprising at least one metal strip layer, said metal strip comprising at least two portions, of which a first portion is deposited on said first substrate and of which a second portion is deposited in the first electrolyte micro channel, said first and second portions being connected electrically; and
a second substrate comprising, on one of its surfaces and arranged opposite to said surface of the first substrate, the analyte micro channel and the first liquid membrane micro channel.

Said analyte micro channel and said liquid membrane micro channel and said electrolyte micro channel are structured so as to provide, at each of their extremities, an opening intended for an inlet and outlet of their respective liquid solution.

The ion-selective sensor is further characterised in that the assembly of said first and said second substrates closes said analyte micro channel, said first electrolyte micro channel and said first liquid membrane micro channel, and is further also characterised in that a first reservoir is formed, after said assembly, at the interface between the analyte micro channel and the electrolyte micro channel, said first reservoir being connected to said analyte micro channel, to the first electrolyte micro channel and to the first liquid membrane micro channel and is intended to receive and retain an ion-selective liquid membrane able to separate the analyte and electrolyte liquids drawn in their respective micro channels. The realisation of a confluent reservoir, interconnecting micro channels for the analyte solution, the electrolyte solution and the liquid membrane solution allows to achieve a fully integrated ion-sensor on a microchip, leading to a lower cost and also having the property of a long-term stability, which are two of the limitations of the devices taught in prior art. The ion-selective sensor has the additional advantage to be stored in a dry environment so that the liquid membrane and the electrolyte solution can be introduced in said sensor just before the ion concentration measurement of the analyte solution. Moreover, the possibility to introduce the liquid membrane immediately before the use of the sensor avoids possible problems coming from the aging of the liquid membrane due to the storage time of the sensor assembly, as well as disruptive phenomena that could be generated by the too long contact between the sensor assembly and the plasticizer-based liquid membrane.

In an embodiment the liquid membrane micro channel and/or the analyte micro channel and/or the electrolyte micro channel may be realised by two portions, one portion being structured on the first substrate and a second portion on the second substrate.

In an embodiment the first reservoir is realised by arranging a first recess only in the first substrate. Alternatively the first reservoir may be realised by arranging a second recess arranged in said second substrate, said recess forming the reservoir after assembly of the first and second substrates.

The first reservoir may also be realised by the alignment, and subsequent assembly of the two substrates comprising a first recess arranged in said first substrate and a second recess arranged in said second substrate, said second recess being arranged opposite to said first recess when the substrates are assembled.

In an embodiment a porous layer may be arranged in said reservoir. The porous layer may be, preliminary to the assembly of the first substrate and the second substrate, arranged into one of the mentioned recesses The advantage of using a porous layer is that the porous layer may be soaked with ion-selective liquid membrane solution prior to the assembly of first substrate and second substrate. An embodiment of the ion-selective sensor comprising a porous layer, in which the liquid membrane can be soaked, has an improved stability of the liquid membrane and a better reliability of the separation of the analyte solution and the electrolyte solution.

Different embodiments of the ion-selective sensor may be devised wherein said first electrolyte micro channel, the first liquid membrane micro channel and the analyte micro channel are connected to the said first reservoir, and arranged with any relative angle between each of said first electrolyte, first liquid membrane and analyte micro channels. This design flexibility allows arranging the micro channel configuration to the specific application and use of the ion-selective sensor.

The substrates of the ion-selective sensor may be made in any structural material, preferably a polymeric material. This allows achieving a low cost for the ion selective sensor.

The object of the invention is also attained by an ion-selective device comprising a first and a second ion-selective sensors. To achieve this, a second ion-selective sensor is arranged to the analyte micro channel of the first ion-selective sensor, this second ion-selective sensor comprising a second reservoir, different from the first reservoir and arranged separated from the said first reservoir. In this embodiment different variants of the liquid membrane micro channel are possible: a single liquid membrane micro channel may be connected to each of the two reservoirs or each reservoir may be connected to a different liquid membrane micro channel, each drawing a separate and possibly different ion-selective liquid solution. The two electrolyte micro channels of the ion-selective device may be identical or they may be different and they may draw the same or different electrolyte solutions.

The object of the invention is also attained by an ion-selective system comprising a plurality of ion sensors and/or ion-selective devices arranged on a single analyte micro channel, which can be a straight channel, but also a curved channel, and to which the electrolyte and the liquid membrane micro channels of each of said plurality of ion-sensors are arranged to form any angle with the single analyte micro channel. The advantage of arranging different ion-sensors and/or ion-selective devices on a single analyte micro channel is that more than two ion species can be detected in a single analyte solution.

Furthermore, such an arrangement of the ion-selective system allows for a high integration density of such an ion-selective sensor. The plurality of ion-sensors may each be arranged with a porous layer arranged in their respective reservoirs, but not all of said plurality of ion sensors does necessarily have a porous layer arranged in their corresponding reservoir.

The invention also relates to a method to measure on concentration of an analyte solution by the ion-selective sensor.

In an embodiment of the method comprising an ion-selective sensor comprising a reservoir as defined above the following steps are taken;
providing the ion-selective sensor comprising a reservoir, as described above;
treating the surface of the reservoir to protect the first substrate and the second substrate from the interaction with the liquid membrane solution;
treating the surface of the reservoir to become hydrophobic;
adding the liquid membrane to the inlet of the liquid membrane micro channel and letting it enter in the reservoir by capillarity;
letting the liquid membrane stabilize and/or gelify;
pumping the electrolyte solution in the electrolyte micro channel
pumping in the analyte micro channel a pre-conditioning solution;
waiting until the three liquid phases, i.e. the analyte solution, the liquid membrane and the electrolyte solution equilibrate;
before starting the measurements, renew the analyte micro channel solution and the internal electrolyte solution by pumping fresh solution in the analyte micro channel and the internal electrolyte channels;
starting a calibration cycle by pumping one or more calibration solutions, comprising a precisely determined composition and on concentrations of a specific ion species in the analyte micro channel;
after the end of the calibration cycle, starting a rinsing cycle by pumping a rinsing solution in the analyte micro channel;
pumping the analyte solution in the analyte channel and perform the ion concentration measurement of the analyte solution;
repeating the measurement steps with other analyte solutions if needed; and
after the end of the measurement cycle, starting a rinsing cycle by pumping a rinsing solution in the analyte micro channel.

In an embodiment of the method of measuring ion concentration of an analyte solution, prior to the introduction of the liquid membrane solution in the liquid membrane micro channel and the reservoir, a gas is flown in the electrolyte micro channel and the analyte micro channel, this in order to keep in place the liquid membrane when introducing the analyte and electrolyte solution, and to avoid the mixing of the liquid membrane, the analyte solution and the electrolyte solution.

Another method of measuring ion concentration of an analyte solution comprises the steps of:
providing the ion-selective sensor comprising a reservoir in which a porous layer is arranged, as described above;
adding a liquid membrane to the inlet of the liquid membrane micro channel;
letting the liquid membrane be transported, by capillarity, through the liquid membrane micro channel to the reservoir;
letting the liquid membrane soak the porous layer;
waiting for the liquid membrane to equilibrate within the porous layer;
pumping the electrolyte solution in the electrolyte micro channel;
pumping a pre-conditioning solution, which is typically an electrolyte solution of composition similar to the analyte solution of interest, in the analyte micro channel;
waiting for the three liquid phases to equilibrate;
before starting the measurements, renewing the analyte solution in the analyte micro channel and renewing the internal electrolyte solution in the electrolyte micro channel by pumping fresh solution in their respective channels;
starting a calibration cycle by pumping one or more calibration solutions, comprising a precisely determined composition and on concentrations of a specific ion species in the analyte micro channel;
after the end of the calibration cycle, starting a rinsing cycle by pumping a rinsing solution in the analyte micro channel;
pumping the analyte solution in the analyte channel and performing the ion concentration measurement of the analyte solution;
repeating the measurement steps with other analyte solutions if needed; and
after the end of the measurement cycle, starting a rinsing cycle by pumping a rinsing solution in the analyte micro channel.

### BRIEF DESCRIPTION OF THE DRAWINGS

The natural advantages and various additional features of the invention will appear more fully upon consideration of the illustrative embodiments in the accompanying drawings:

FIG. 1 illustrates a top view of the reservoir to which the liquid membrane micro channel, the analyte micro channel and electrolyte micro channel are connected;

FIG. 2 illustrates a top view of another arrangement of a reservoir to which the liquid membrane micro channel, the analyte micro channel and electrolyte micro channel are connected;

FIG. 3a illustrates a cross-section of the reservoir to which the liquid membrane micro channel, the analyte micro channel and electrolyte micro channel are connected;

FIG. 3b illustrates another cross-section of the reservoir to which the liquid membrane micro channel, the analyte micro channel and electrolyte micro channel are connected;

FIG. 3c illustrates a cross-section of a liquid membrane micro channel realized by the assembly of a first substrate comprising a recess and a second substrate comprising also a recess;

FIG. 3d illustrates a cross section of a reservoir, along the liquid membrane micro channel filled with a liquid membrane solution;

FIG. 4 illustrates a top view of the microfluidic chip comprising a porous layer arranged in the reservoir connecting the liquid membrane micro channel, the analyte micro channel and the electrolyte micro channel;

FIG. 5a illustrates a cross-section of the junction of the liquid membrane-, the electrolyte- and the analyte micro channels to a reservoir in which a porous layer is arranged;

FIG. 5b illustrates another cross-section of the junction of the liquid membrane micro channel, the electrolyte micro channel and the analyte micro channels to a reservoir in which a porous layer is arranged;

FIG. 6 illustrates a cross-section of the microfluidic chip, comprising a porous layer, along the analyte micro channel;

FIG. 7 illustrates a cross-section of the microfluidic chip comprising a porous layer, along the electrolyte micro channel;

FIG. 8 illustrates a cross-section of the microfluidic chip comprising a porous layer, along the liquid membrane micro channel;

FIG. 9 illustrates an arrangement of a liquid membrane micro channel, an analyte micro channel and an electrolyte micro channel comprising a porous layer separating the analyte solution and the electrolyte solution;

FIG. 10 illustrates a detailed view of an arrangement of a junction of a liquid membrane micro channel, an analyte micro channel and a electrolyte micro channel comprising a porous layer separating the analyte solution and the electrolyte solution; and

FIG. 11 illustrates an ion-selective device comprising two ion-selective sensors connected to the same analyte micro channel.

### DETAILED DESCRIPTION

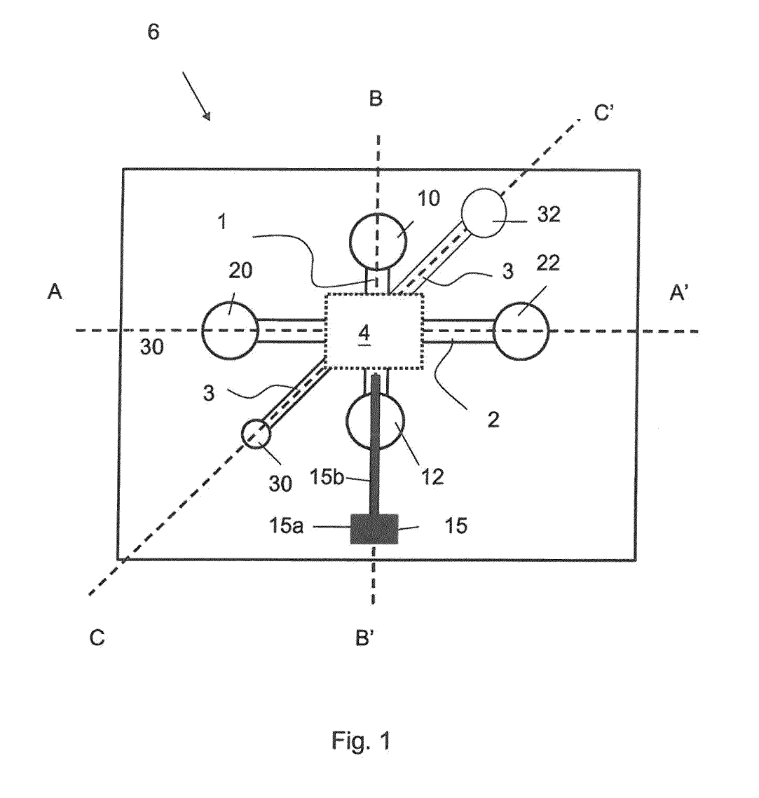

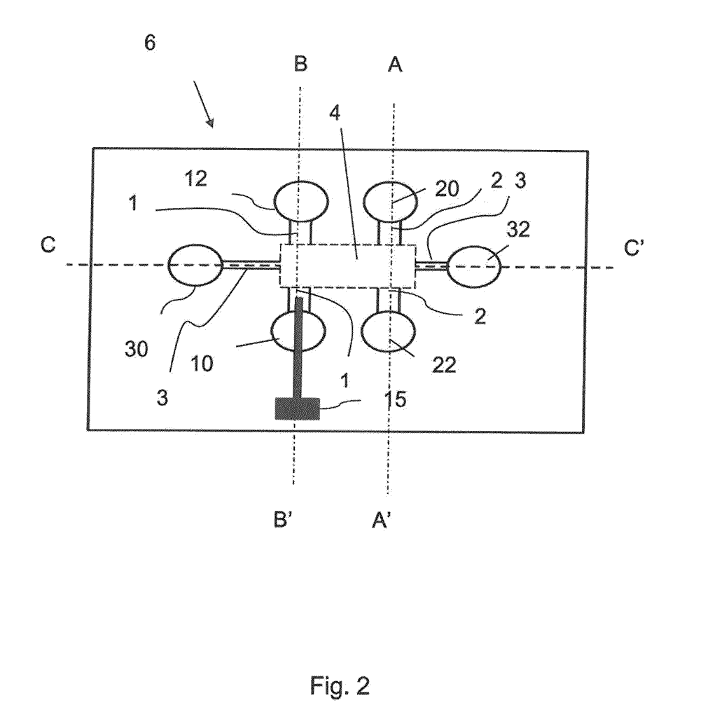

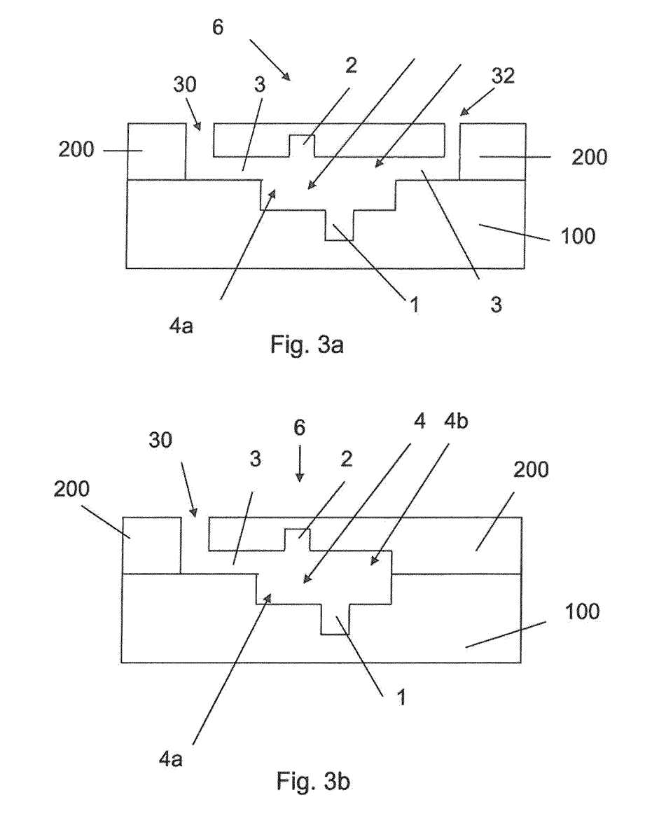

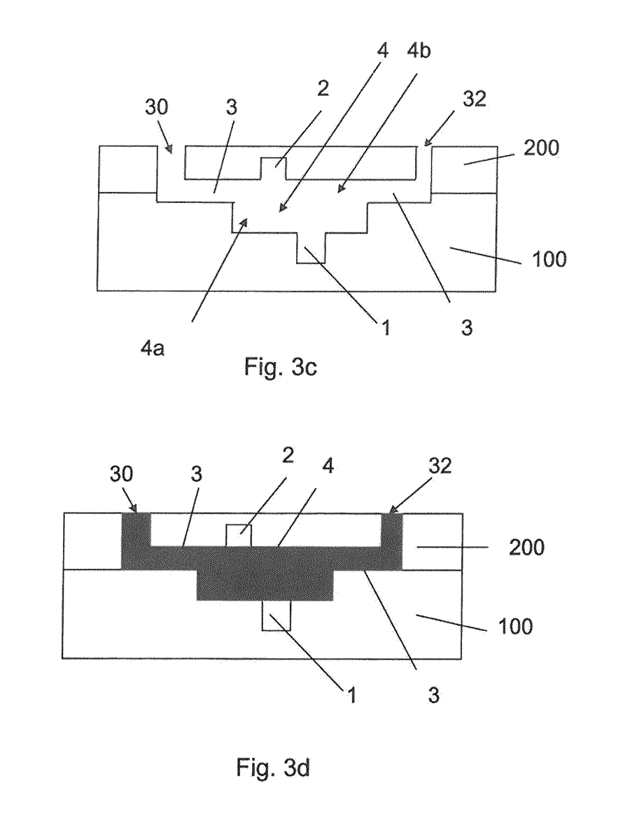

According to a generic embodiment of the invention, illustrated in FIG. 1, FIG. 2 and FIG. 3a, an ion-selective sensor 6 comprises three microfluidic micro channels, arranged inside the ion-selective sensor 6:
an analyte micro channel 2, arranged to draw en analyte solution;
a first liquid membrane micro channel 3 arranged to draw an ion-selective liquid membrane solution; and
a first electrolyte micro channel 1, arranged to draw an electrolyte solution.

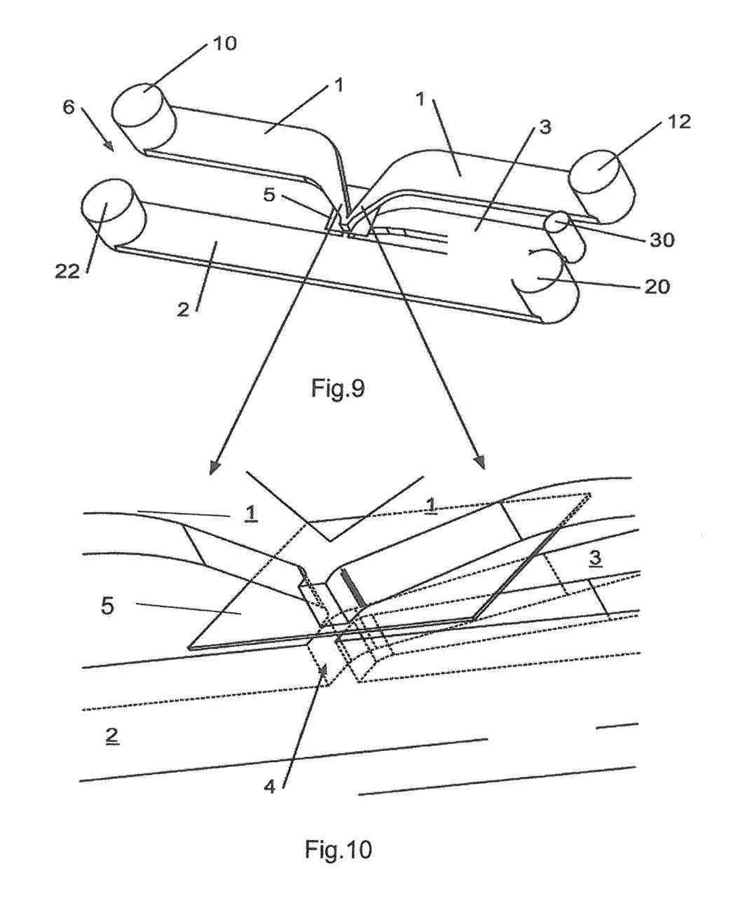

The ion-selective sensor 6 further comprises:
a first substrate 100 comprising the first electrolyte micro channel 1 integrated on one of the surfaces of said first, substrate 100;
at least one metal strip layer 15, as shown in FIG. 8, that comprises at least two portions 15a and 15b, of which a first portion 15a is deposited on said first substrate 100 and a second portion 15b is deposited on the surface of the first electrolyte micro channel 1, said portions being connected electrically;
a second substrate 200 that comprises, on one of its surfaces, arranged opposite to said surface of the first substrate 100, said analyte micro channel 2 and said first liquid membrane micro channel 3. The analyte micro channel 2 and the first liquid membrane micro channel 3 are structured at their extremities, as illustrated in the top view of FIG. 1 and in the cross-section view of FIG. 3a, to present openings intended for their respective inlets 20, 30 and respective outlets 22, 32. The cross-section view of FIG. 3a corresponds to the cross-section according to the section C-C′ of the top view in FIG. 1.

The ion-selective sensor 6 comprises, after the assembly of said first substrate 100 and said second substrate 200, a completely formed analyte micro channel 2, a completely formed first electrolyte micro channel 1, and a completely formed first liquid membrane 3 micro channels.

The ion selective sensor 6 has also a first reservoir 4, arranged at the interface of the first substrate 100 and the second substrate 200 and forming a chamber to which the liquid membrane micro channel 3, the analyte micro channel 2, the electrolyte micro channel 1 are connected and which is intended to receive the ion-selective liquid membrane solution, the analyte solution and the electrolyte solution, by means of their respective micro channels connected to that reservoir 4.

In order to assure that the analyte solution and the electrolyte solution can remain separated by the ion-selective liquid membrane solution in that reservoir, different structural embodiments and liquid introduction methods have been devised and will be explained further in more detail.

The electrochemical properties and mechanism of an ion-selective liquid membrane are well known to a person skilled in the art. The ion-selective liquid membrane is herein also called the liquid membrane. The liquid membrane has an advantageously chosen chemical composition and property for a specific ion-selective electrode, so that the analyte solution and electrolyte solution can be separated by said liquid membrane. Its properties are based on the use of ionophores and lipophilic substances that do not diffuse out of the liquid membrane. The ionophore in the liquid membrane allows the analyte ion to solubilize in the liquid membrane and an equilibrium of the analyte ion needs to be achieved at the interface of the analyte and the liquid membrane.

A great variety of compositions of liquid membranes can be used and are chosen in function of the analyte solution, the electrolyte solution, the desired surface tension properties of the deployed solutions and also the flow properties of said liquid membrane.

FIG. 3d illustrates a cross-section of the reservoir 4 of the liquid membrane micro channel 3, the electrolyte micro channel 2 and the analyte micro channel 1, with an ion-selective liquid membrane solution drawn through said reservoir 4. This may be achieved, for example, as further described in the method of the invention, by introducing a gas into each of the analyte micro channel and the electrolyte micro channel, or also by using capillary effects. In FIG. 3a-d the geometry of the reservoir 4 is not drawn to scale and different configurations and geometries of the reservoir 4 may be devised. The cross-sections of FIG. 3a-d all represent a section according to the line C-C′ of FIG. 1.

Typical widths of the analyte micro channel 2, the electrolyte micro channel 1 are between 10 μm and 1 mm, preferably 500 μm. Typical widths of the liquid micro channel are between 10 μm and 500 μm, preferably 100 μm. Typical lengths of the micro channels are between 1 mm and 20 mm, preferably 15 mm. Typical dimensions (i.e. width, length and height) of the reservoir are between 10 μm×10 μm×10 μm and 1000 μm×1000 μm×100 μm, preferably 500 μm×500 μm×20 μm.

The materials used for the first substrate 100 and the second substrate 200 are preferably chosen among thermoplastic materials. Other materials that can be microstructured by etching or laser techniques may be devised as well. Said substrates may be microstructured with micromechanical techniques, or by chemical etching techniques, or by laser machining techniques, or by hot embossing techniques, or by injection moulding techniques, or by lamination techniques or any combination thereof.

In a variant of the generic embodiment, illustrated in FIG. 3d, the first liquid membrane micro channel 3 can be realised by structuring, before assembly of said first substrate 100 and said second substrate 200, a first portion 3a of the first liquid membrane micro channel 3 on said first substrate 100 and a second portion 3b of the first liquid membrane micro channel 3 on said second substrate 200, said first liquid membrane micro channel 3 being formed completely after the alignment and assembly of the first substrate 100 and the second substrate 200.

In a variant of the generic embodiment, the liquid membrane micro channel 3 may present only an inlet 30 and no outlet, as shown in FIG. 3b.

The analyte micro channel 2, the electrolyte micro channel 1 and the liquid membrane micro channel 3 may be straight micro channels. Alternatively the analyte-2, electrolyte-1 and liquid membrane 3 micro channels may be curved micro channels. The widths and depths of the micro channels may be constant or may vary along their length.

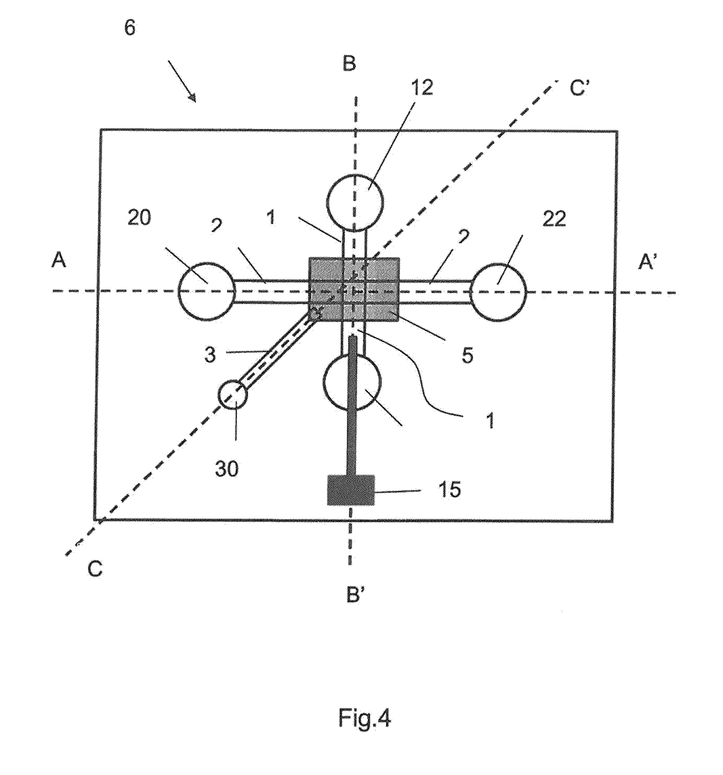

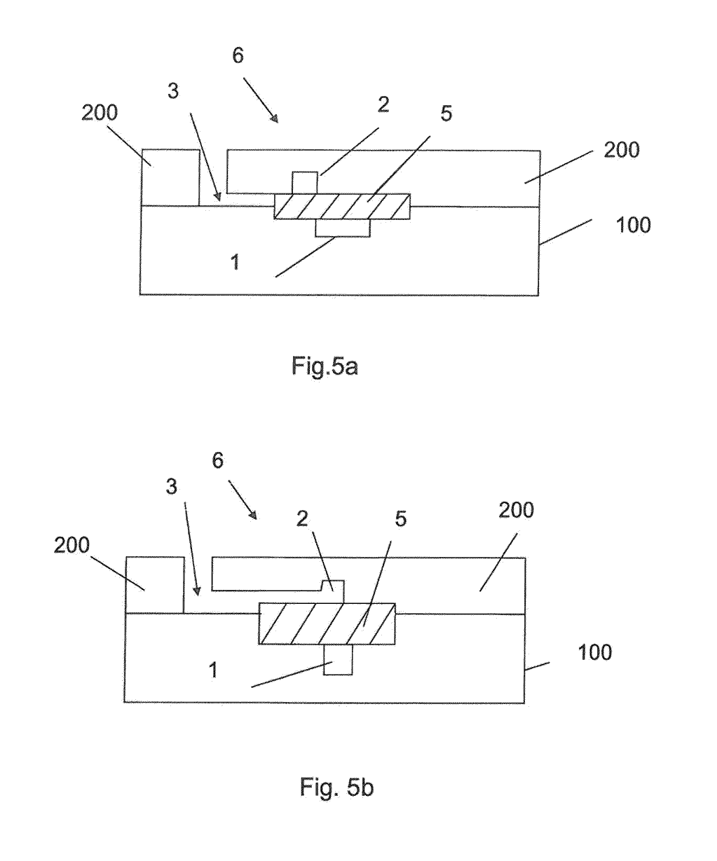

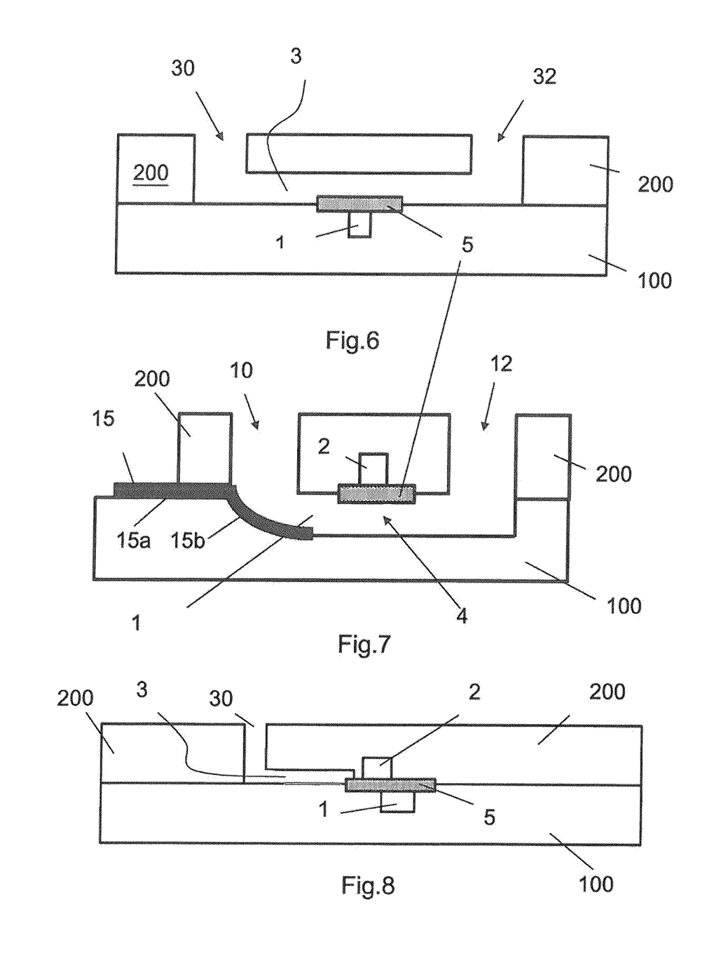

In another embodiment of the invention, illustrated in FIGS. 4-10 a porous layer 5 is arranged inside the reservoir 4 of the ion-selective sensor 6. FIGS. 6, 7 and 8 show the cross-section of such an ion-selective sensor 6 comprising a porous layer 5. FIG. 6 corresponds to the cross-section of FIG. 4 according to the line A-A′, FIG. 7 corresponds to the cross-section of FIG. 4 according to the line B-B′ and FIG. 8 corresponds to the cross-section of FIG. 4 according to the line C-C′. Said porous layer 5 may be arranged in said recess 4a of the first substrate 100 before assembly with the second substrate 200. As an alternative arrangement the porous layer 5 may be arranged to a recess 4b of the second substrate 200 before said assembly. Depending on the desired configuration and geometry of said reservoir 4 the thickness of the porous layer 5 may be smaller or equal to the depth of said recesses.

There are different possible arrangements of the micro channels 1, 2, 3 and said reservoir 4 to which the micro channels 1, 2, 3 are connected and confluent. In FIG. 9 and FIG. 10, a 3D view of an embodiment is shown wherein the first liquid membrane micro channel 3 is connected to the porous layer 5 arranged in the reservoir 4, allowing to soak said porous layer 5 with the liquid membrane solution provided by the liquid membrane micro channel 3. As explained further in the method according to the invention, the analyte and electrolyte solutions are brought into contact with the liquid membrane located in reservoir 4 after the stabilisation of the liquid membrane and said analyte and electrolyte solutions stay separated by the porous layer soaked with said liquid membrane solution.

The materials for the porous layer 5 are preferably chosen among plastic porous materials.

Different assembly methods are possible to arrange said porous layer 5 into the reservoir 4. These are standard assembly techniques and will not be further explained in detail.

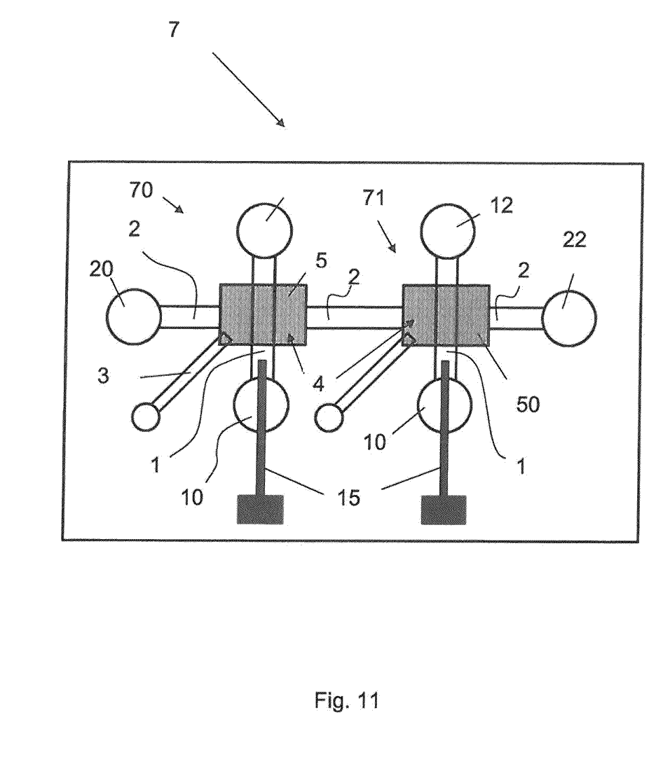

In an ion-sensor device 7, two ion-sensors may be arranged to the analyte micro channel 2, as illustrated in FIG. 11. In the ion-sensor device of FIG. 11 the two electrolyte micro channels 1, 11 may have the same geometry or they may have a different geometry. They may also draw the same electrolyte solution or a different electrolyte solution. In the ion sensor device of FIG. 11 the two liquid membrane micro channels 3, 31 may have the same geometry or they may have a different geometry. They may also draw the same liquid membrane solution or a different liquid membrane solution. The two porous layers 5, 50 arranged into the two reservoirs 4, 40 may have the same geometry or they may have a different geometry and the materials used for the tow porous layers 5, 50 may be different.

The invention relates also to an ion-sensor system, differing from the ion-sensor device 7 of FIG. 11, in that more than 2 ion-sensors are arranged to the same analyte micro channel 2. The analyte micro channel 2 must not be necessarily a straight micro channel and may be arranged as a curve on the surface of said second substrate 200.

The present invention is not limited to the realisation of an ion-sensor comprising microstructured microfluidic micro channels realised in two substrates that are subsequently aligned and assembled. The person skilled in the art will be able, with the description of the present invention, to devise the realisation of an ion-selective sensor 6 based on the assembly of at least three microstructured wafers.

A method to measure ion concentration of an analyte solution by the ion selective sensor 6 of the invention will now be described in more detail.

In an embodiment of the method to measure on concentration of an analyte solution by an ion-selective sensor comprising a reservoir 4 as defined above, the following steps are taken:
the ion-selective sensor 6 comprising a reservoir 4, as described above, is provided;
the surface of the reservoir 4 is treated to protect the first substrate 100 and the second substrate 200 from the interaction with the liquid membrane solution; by for example coating the micro channels walls with a glass-like material (e.g. by sol-gel treatment);
the surface of the reservoir 4 is then treated to become hydrophobic; a possibility is to treat the oxide-based coating with a silanizing agent;
the liquid membrane is added to the inlet of the liquid membrane micro channel 3 and it is introduced in the reservoir 4 by capillarity. Letting the liquid membrane stabilize and/or gelify; typically for 15 to 24 hours, if the liquid membrane has been added with solvents, this time is necessary for the solvent to evaporate;
pumping the electrolyte solution in the electrolyte micro channel 1;
pumping in the analyte micro channel 2 a pre-conditioning solution;
waiting for the three liquid phases, i.e. the analyte solution, the liquid membrane and the electrolyte solution to equilibrate, typically for 24 hours. The equilibration time is needed for the liquid membrane to hydrate and for the ion equilibrium at the interfaces to be achieved;
before starting the measurements, the analyte micro charmed solution and the internal electrolyte solution are renewed by pumping a fresh solution in the analyte micro channel 2 and the electrolyte channel 1;
starting a calibration cycle by pumping one or more calibration solutions, comprising a precisely determined composition and on concentrations of a specific on species in the analyte micro channel 2;
after the end of the calibration cycle, starting a rinsing cycle by pumping a rinsing solution in the analyte micro channel 2;
pumping the analyte solution in the analyte micro channel 2 and perform the on concentration measurement of the analyte solution;
repeating the measurement steps with other analyte solutions if needed; and
eventually, after the end of the measurement cycle, starting a rinsing cycle by pumping a rinsing solution in the analyte micro channel 2.

In an embodiment of the method of measuring ion concentration of an analyte solution as described above, a gas is flown in the electrolyte micro channel 1 and the analyte micro channel 3, prior to the introduction of the liquid membrane solution in the liquid membrane micro channel 3 and the reservoir 4, this in order to keep in place the liquid membrane when introducing the analyte and electrolyte solution, and to avoid the mixing of the liquid membrane, the analyte solution and the electrolyte solution.

In another embodiment of the method of measuring ion concentration of an analyte solution by the ion-selective sensor 6 comprising a reservoir 4 comprising a porous layer 5, the following steps are taken:
providing the on selective sensor 6 comprising a reservoir 4 in which a porous layer 5 is arranged, as described above;
adding a liquid membrane to the inlet 30 of the liquid membrane micro channel 3, let the liquid membrane be transported by capillarity through the liquid membrane micro channel 3 to the reservoir 4;
letting the liquid membrane soak the porous layer 5;
waiting for the liquid membrane to equilibrate within the porous layer 5, typically for 15 to 24 hours, the liquid membrane being in most of the cases prepared with plasticizing agents, a certain time is needed to plasticize the porous plastic material and reach a stable layer;
pumping the electrolyte solution in the electrolyte micro channel 1;
pumping a pre-conditioning solution in the analyte micro channel 3;
waiting until the three liquid phases of the analyte solution, the electrolyte solution and the liquid membrane solutions equilibrate for some hours, typically 12 h;
before starting the measurements, renewing the analyte solution in the analyte microchannel and renewing the internal electrolyte solution in the electrolyte micro channel 1 by pumping fresh solution in their respective channels;
starting a calibration cycle by pumping one or more calibration solutions, comprising a precisely determined composition and ion concentrations of a specific on species in the analyte micro channel 2;
after the end of the calibration cycle, starting a rinsing cycle by pumping a rinsing solution in the analyte micro channel 2;
pumping the analyte solution in the analyte channel and performing the on concentration measurement, of the analyte solution;
repeating the measurement steps with other analyte solutions if needed; and
after the end of the measurement cycle, starting a rinsing cycle by pumping a rinsing solution in the analyte micro channel 2.

Although the present invention has been described with reference to specific embodiments, variations thereto are possible without departing from the scope of the invention as described by the appended claims.

For example, the realisation of the micro channels and their inlets and outlets may be realised in different arrangements that the ones explained. The inlets and outlets may be formed by partially structuring two portions, one portion being structured in the first substrate 100 and the second portion being structured in the second substrate 200 and at the same time the corresponding micro channels may be structured in one or both of first 100 and second 200 substrate but always so that after assembly of the first 100 and second 200 substrate the micro channels comprise an net and an outlet.

Also, the person skilled in the art may devise embodiments wherein different ion-selective sensors, ion-selective devices or ion-selective systems are assembled on top of each other, possibly interconnected by advantageously chosen fluidic interconnections.

1-10. (canceled)

11. A micro machined chip comprising an analyte micro channel adapted to draw an analyte solution, and a first liquid membrane micro channel adapted to draw a liquid membrane solution, and a first electrolyte micro channel adapted to draw an electrolyte solution, wherein said micro machined chip further comprises:
a first substrate comprising said first electrolyte micro channel integrated on one of its surfaces; the first electrolyte micro channel being structured at its extremities to present an opening intended for an inlet and a further opening intended for an outlet of the electrolyte solution;
at least one metal strip layer, comprising at least two portions, of which a first portion is deposited on said first substrate and a second portion is deposited in the first electrolyte micro channel, said portions being connected electrically;
a second substrate comprising on one of its surfaces, arranged opposite to said surface of the first substrate, said analyte micro channel, and said first liquid membrane micro channel, the analyte micro channel being structured at its extremities to present an opening intended for an inlet and a further opening intended for an outlet of the analyte solution, and the first liquid membrane micro channel being structured at its extremities to present an opening intended for an inlet and a further opening intended for an outlet of the liquid membrane; said first substrate and said second substrate close said analyte micro channel, first electrolyte micro channel and first liquid membrane micro channel,
a first reservoir being formed, at the interface between the analyte micro channel and the first electrolyte micro channel, said first reservoir being connected to said analyte micro channel, the first electrolyte micro channel and the first liquid membrane micro channel, said first reservoir comprising a first porous layer retaining a liquid membrane that separates the analyte solution and the electrolyte solution, said analyte solution and the electrolyte solution being drawn in their respective micro channels.

12. The micro machined chip of claim 11, wherein the first liquid membrane micro channel and/or the analyte micro channel comprises two portions, one portion being structured on the first substrate and a second portion being structured on the second substrate.

13. The micro machined chip of claim 11, wherein said first reservoir is a first recess arranged in said first substrate.

14. The micro machined chip of claim 11, wherein said first reservoir is a second recess arranged in said second substrate.

15. The micro machined chip of claim 11, wherein said first reservoir comprises a first recess arranged in said first substrate and comprises a second recess in said second substrate, said second recess being arranged opposite to said first recess.

16. The micro machined chip of claim 11, wherein said first electrolyte micro channel, said first liquid membrane micro channel and said analyte micro channel are connected to said first reservoir and arranged with an angle between each of said first electrolyte micro channel, said first liquid membrane micro channel and said analyte micro channel.

17. The micro machined chip of claim 12, wherein said first electrolyte micro channel, said first liquid membrane micro channel and said analyte micro channel are connected to said first reservoir and arranged with an angle between each of said first electrolyte micro channel, said first liquid membrane micro channel and said analyte micro channel.

18. The micro machined chip of claim 15, wherein said first electrolyte micro channel, said first liquid membrane micro channel and said analyte micro channel are connected to said first reservoir and arranged with an angle between each of said first electrolyte micro channel, said first liquid membrane micro channel and said analyte micro channel.

19. The micro machined chip of claim 11, wherein the substrates are made in any structurable material, preferably a polymeric material.

20. The micro machined chip of claim 15, wherein the substrates are made in any structurable material, preferably a polymeric material.

21. The micro machined chip of claim 16, wherein the substrates are made in any structurable material, preferably a polymeric material.

22. An ion-selective device, comprising at least a first micro machined chip according to claim 11, and a second micro machined chip comprising a second reservoir comprising a second porous layer arranged to said first analyte micro channel, said ion selective device comprising a second electrolyte micro channel and a second liquid membrane micro channel arranged to said second reservoir, said second porous layer retaining a liquid membrane that separates the analyte solution and the second electrolyte solution, said analyte solution and the second electrolyte solution being drawn in their respective micro channels.

23. An ion-selective system comprising more than 2 micro machined chip according to claim 11.

24. An ion-selective system comprising an ion-selective device according to claim 22.

25. A method of measuring ion concentration of an analyte solution comprising the steps of:
providing the micro machined chip according to claim 11;
adding a liquid membrane to the inlet of the first liquid membrane micro channel;
letting the liquid membrane be transported, by capillarity through the first liquid membrane micro channel to the reservoir;
letting the liquid membrane soak the porous layer;
waiting for the liquid membrane to equilibrate within the porous layer;
pumping the electrolyte solution in the electrolyte micro channel;
pumping a preconditioning solution in the analyte micro channel;
waiting for the three liquid phases to equilibrate for some hours, typically overnight;
before starting the measurements, renewing the analyte solution in the analyte micro channel and renewing the internal electrolyte solution in the first electrolyte micro channel by pumping fresh solution in their respective channels;
starting a calibration cycle by pumping one or more calibration solutions, comprising a precisely determined composition and on concentrations of a specific ion species in the analyte micro channel;
after the end of the calibration cycle, starting a rinsing cycle by pumping a rinsing solution in the analyte micro channel;
pumping the analyte solution in the analyte channel and perform the ion concentration measurement of the analyte solution;
repeating the measurement steps with other analyte solutions if needed;
after the end of the measurement cycle, starting a rinsing cycle by pumping a rinsing solution in the analyte micro channel.
